(19) United States
(12) Patent Application Publication
(10) Pub. No.: US 2020/0254706 A1
(43) Pub. Date: Aug. 13, 2020

(54) APPARATUS FOR COMPACTING YARD WASTE AND KIT FOR ASSEMBLY THEREOF

(71) Applicant: Rolf OHRSTROM, Palgrave (CA)

(72) Inventor: Rolf OHRSTROM, Palgrave (CA)

(21) Appl. No.: 16/783,769

(22) Filed: Feb. 6, 2020

Related U.S. Application Data
(60) Provisional application No. 62/802,456, filed on Feb. 7, 2019.

(51) Int. Cl. B30B 15/06; F16B 9/00; A01D 11/00

(52) U.S. Cl. CPC B30B 15/062; A01D 11/00; F16B 9/054

(57) ABSTRACT

An apparatus for compacting yard waste is disclosed. The apparatus comprises a shaft and a base adapted to crush yard waste. The apparatus is assembled by releasable coupling of the shaft and the base.

### FIELD

The present disclosure is related to an apparatus for compacting yard waste, and a kit for assembling such an apparatus.

### BACKGROUND

Property owners enjoy having a variety of plant species on their property that lose their leaves or shed some organic material seasonally. In some instances, neighboring property owners have plant species that shed organic matter onto a property owner's land. Municipal and other governments have implemented programs to collect the aforementioned organic material, typically stored and collected in paper bags.

### BRIEF DESCRIPTION OF THE DRAWINGS

Reference will now be made, by way of example, to the accompanying drawings which show example embodiments of the present application, and in which:

FIG. 1A is a schematic illustration of parts of a kit for assembling an example apparatus for compacting leaves;

FIG. 1B is a schematic illustration of an example apparatus for compacting leaves;

FIG. 2A is a perspective view of another embodiment of a tamper base;

FIG. 2B is a top view of the tamper base illustrated in FIG. 2A;

FIG. 2C is a side elevation view of one side of the tamper base illustrated in FIG. 2A, taken along line 2C in FIG. 2B

FIG. 2D is a side elevation view of another side of the tamper base illustrated in FIG. 2A, taken along line 2D in FIG. 2D;

FIG. 2E is a bottom view of the tamper base illustrated in FIG. 2A;

FIG. 3 is a perspective view of an alternate embodiment of a shaft;

FIG. 4A is a top perspective view of another embodiment of an apparatus for compacting leaves;

FIG. 4B is a front elevation view of the apparatus illustrated in FIG. 4A;

FIG. 4C is a top perspective of the apparatus illustrated in FIG. 4A, in exploded form;

FIG. 4D is a front elevation view of the apparatus illustrated in FIG. 4A, in exploded form;

FIG. 5A is a top perspective view of another embodiment of a tamper base of an apparatus for compacting leaves;

FIG. 5B is a top plan view of the tamper base illustrated in FIG. 5A;

FIG. 5C is a bottom plan view of the tamper base illustrated in FIG. 5A, in exploded form;

FIG. 5D is a side elevation view of the tamper base illustrated in FIG. 5A, in exploded form;

FIG. 5E is a front elevation view of the tamper base illustrated in FIG. 5A, in exploded form; and

FIG. 5F is a sectional view of the tamper base illustrated in FIG. 5A, taken along the lines A-A in FIG. 5B.

### DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout.

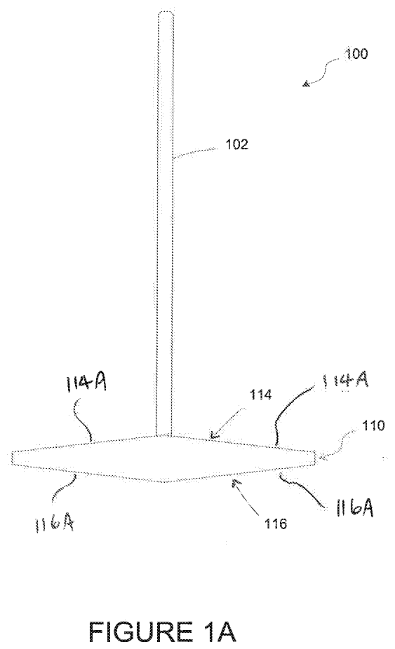

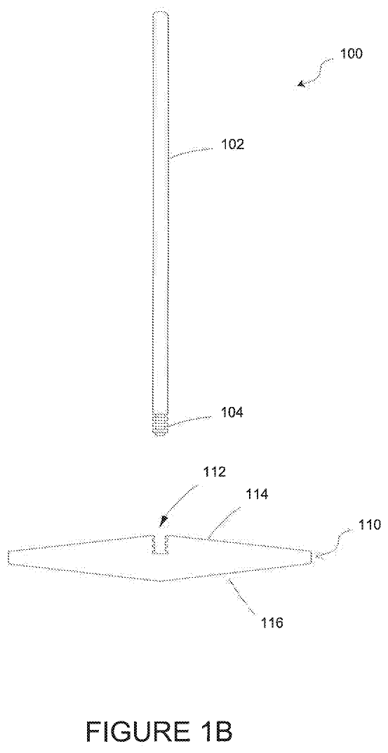

Referring now to FIG. 1A, an apparatus 100 for compacting solid yard waste (such as, for example, leaves) is disclosed, comprising a base 110 and a shaft 102. The shaft 102 is configured for gripping by a user such that a force, applied by the user, is transmittable by the shaft 102 to the base 110 for effecting compaction of solid yard waste.

The base 110 includes a lower surface 116. The lower surface 116 is configured for crushing solid yard waste. In this respect, in some embodiments, for example, the lower surface 116 is characterized by alternating ridges and channels to facilitate the crushing of organic material. The shaft 102 and the base 110 are co-operatively configured such that size reduction of yard waste, by the lower surface 16 of the base 110, is effectible in response to application of a force, to the shaft 102, in a downwardly direction. In some embodiments, for example, the size reduction of yard waste, which is effectible by the lower surface 116, is effectible in response to application of a force, to the shaft 102, in a direction that is transverse (for example, orthogonal) to the lower surface 116. In some embodiments, for example, the central longitudinal axis of the shaft 102 is orthogonal to at least a portion of the lower surface 116.

In some embodiments, for example, the base 110 is co-operatively configured with a typical yard waste material bag to facilitate its insertion into such bag for effecting crushing of yard waste material within the bag. In some embodiments, for example, the periphery of the lower surface 116 has a circular shape. In some example embodiments, for example, the periphery of the lower surface 116 has a rectangular shape. In some embodiments, for example, the periphery of the lower surface 16 defines an area of at least 45 square inches, such as, for example, at least 60 square inches, such as, for example, at least 77 square inches.

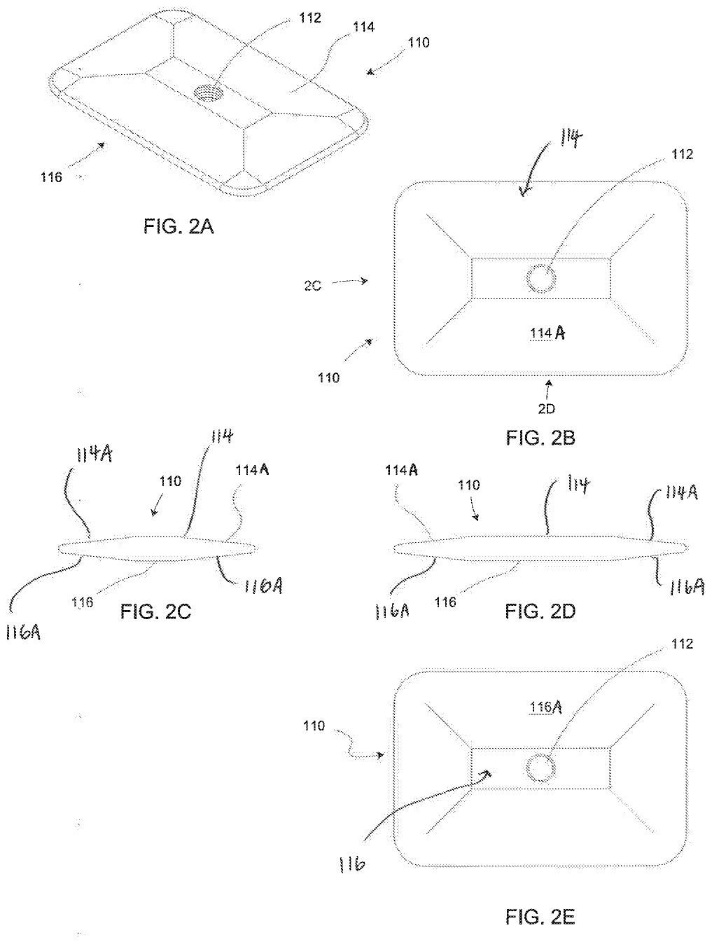

Referring to FIGS. 2A-2E, in some embodiments, for example, a surface portion 116A of the lower surface 116 is configured such that, while the base 110 is being forced to move downwardly through a layer of unconsolidated solid debris (e.g. a pile of leaves), the lower surface portion 116A encourages unconsolidated solid debris to move out of the way of the base 110, and thereby facilitate movement of the base 110 through the layer of unconsolidated solid debris in a downwardly direction. In some embodiments, for example, the downward movement of the base 110 is along an axis, and the unconsolidated solid debris is encouraged to move in an outwardly direction (for example, a radially outwardly direction) relative to the axis. In this respect, in some embodiments, for example, the lower surface portion 116A is tapered upwardly in an outwardly (e.g. radially outwardly) relative to the central longitudinal axis of the shaft 102. In some embodiments, for example, the lower surface portion 116A is smooth. Alternatively, in some embodiments, for example, the lower surface portion 116A is irregular. In some embodiments, for example, the lower surface portion 116A is tapered upwardly at an acute angle of at least three (3) degrees relative to the horizontal, such as, for example at least five (5) degrees relative to the horizontal, such as, for example, at least 10 degrees relative to the horizontal. In some embodiments, for example, there is an absence of uniformity in the angle of the taper of the lower surface portion 116A.

In some embodiments, for example, the base 110 includes a upper surface 114, and the upper surface 114 includes a upper surface portion 114A that is configured for dislodging leaves from the upper surface of the base 110 upon sufficient agitation. In some embodiments, for example, the upper surface portion 114A is tapered downwardly in an outwardly direction (e.g. radially outwardly direction) relative to the central longitudinal axis of the shaft 102. In some embodiments, for example, the upper surface portion 114A is smooth. Alternatively, in some embodiments, for example, the upper surface portion 114A is irregular.

In some embodiments, for example, the base 110 is made of plastic, such as, for example, injection molded plastic. In some embodiments, for example, suitable plastics include polyethylene, polypropylene, polystyrene, polyurethane, ABS, and polyvinylchloride.

In some embodiments, for example, the shaft 102 is elongated. In some embodiments, for example, the shaft 102 is sufficiently long such that, while the base 110 is disposed within a typical organic waste material bag, the shaft 102 extends outside of the waste material bag such that the shaft 102 is grippable by a user for applying a force for effecting crushing of yard waste material within the bad by the lower surface 110. In some embodiments, for example, the shaft 102 has a length of at least 36 inches, such as, for example, at least 48 inches, such as, for example, at least 60 inches.

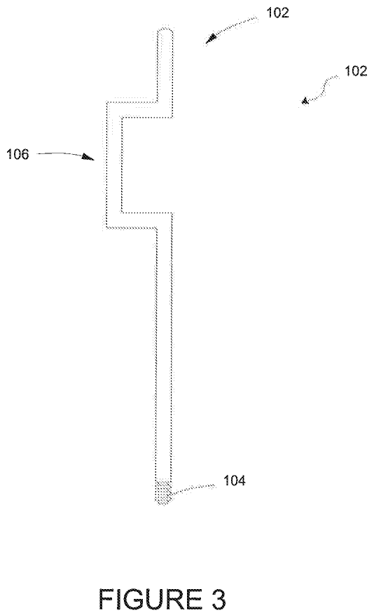

Referring to FIG. 3, in some embodiments, for example, a handle 106 is defined by the shaft. The handle 106 is adapted to allow a user to grip the shaft 102 comfortably. The gripping portion may be a separate member attached to the shaft 102, such as a rubber covering, or the gripping portion may be part of the shaft 102, such as a knurled portion.

The shaft 102 can be made of metal, wood, plastic, or other suitable material. In some embodiments, for example, the shaft 102 includes a gripping portion (or handle), adapted to allow a user to grip the shaft 102 comfortably. In some embodiments, for example, the shaft is obtainable from American Select Tubing, LLC.

In some embodiments, for example, the shaft 102 and the base 110 are releasably coupled to one another. Referring to FIG. 1B, in this respect, in some embodiments, for example, a kit for assembling the apparatus 100 is provided and includes the shaft 102 and the base 110. In some embodiments, for example, the kit includes instructions for assembling the apparatus 100. In some embodiments, for example, the kit includes instructions for effecting size reduction of solid yard waste by using the assembled apparatus 100, as above-described.

In some embodiments, for example, the releasable coupling is with effect that there is an absence, or substantial absence, of rotatabiity of the shaft 102 relative to the base 110. In some embodiments, for example, the absence, or substantial absence, of rotatability includes the absence, or substantial absence, of rotatability of the shaft 102 relative to the base 110, about an axis that is disposed in a plane to which the longitudinal axis of the shaft 102 is orthogonal. In some embodiments, for example, the releasable coupling is with effect that the shaft 102 is fixed, or substantially fixed, to the base 110.

In some embodiments, for example, the shaft 102 defines a first coupling counterpart, and the base 110 defines a second coupling counterpart, and the first and second coupling counterparts are co-operatively configured for interacting such that the releasable coupling is effectible by the interacting of only the first and second counterparts. In this respect, no other components, other than those defined by the shaft 102 and the base 110, are required to effect the releasable coupling.

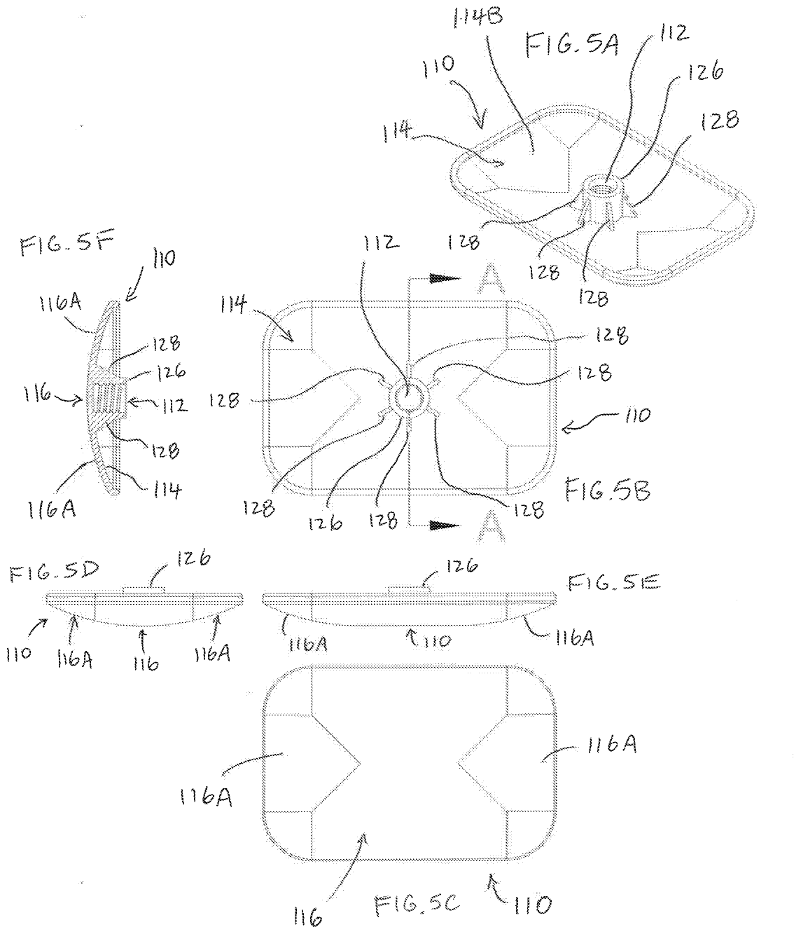

In some embodiments, for example, the releasable coupling includes a threaded coupling, and, in this respect, the shaft 102 and the base 110 are co-operatively configured for threaded coupling to one another. In this respect, in some embodiments, for example, one of the first and second counterparts defines a male connector 104, and the other one of the first and second counterparts defines a female receptacle 112 configured for receiving and threadably coupling to the male connector for enabling assembly of the apparatus. In some embodiments, for example, the first counterpart defines the male connector 104 and the second counterpart defines the female threadable receptacle 112. Referring to FIGS. 2A-2E, in some embodiments, for example, the female receptacle 112 is recessed into the base 110. In some embodiments, for example, the female receptacle 112 is defined within a protrusion 126 (see FIGS. 5A-5F) that extends upwardly from the upper surface of the base 110.

In some embodiments, for example, the female receptacle 112 is defined by a throughbore extending from a first side of the base 110 to an opposite second side of the base 110, such that the threadable connection can be effected from either one of the first and second sides of the base 110. Depending on whether the threadable connection is effected via the first or second side, the first or second side of the base 110 can define the upper surface and the other one of the first and second sides can define the lower surface. In some of these embodiments, for example, the base 110 includes a upper surface 114 that defines the tapered upper surface portion 114A, and also includes a lower surface 116 that defines the tapered lower surface portion 116A. In this respect, in some embodiments, for example, the base 110 is symmetrical about a horizontal plane extending through its central axis.

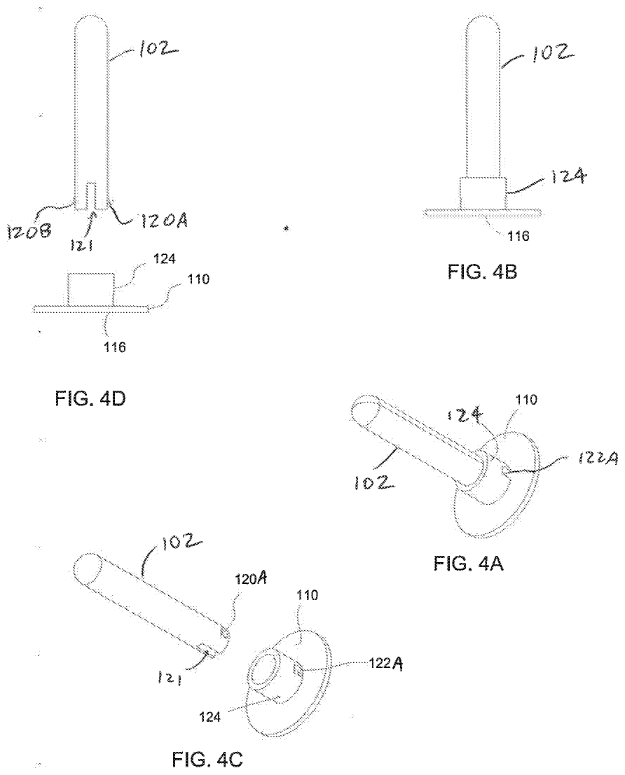

Referring to FIGS. 4A-4F, in some embodiments, for example, the releasable coupling includes an interference fit, and, in this respect, the shaft 102 and the base 110 are co-operatively configured for becoming disposed in an interference fit relationship relative to one another. In some embodiments, for example, to effect the interference fit, one of the first and second counterparts includes a resilient tab, and the other one of the first and second counterparts includes a tab receiver, and the interference fit is established in response to snap fit engagement between the shaft 102 and the base 110 that is effected in response to alignment between the resilient tab and the tab receiver, that is responsive to insertion of the resilient tab into the tab receiver.

In some embodiments, for example, the first counterpart includes a pair of resilient tabs 120A, 120B, and the second counterpart includes corresponding tab receivers (only one, receiver 122A, is shown). In some embodiments, for example, the tab receivers of the second counterpart is defined as tab-receiving apertures (for example, a slot) that are defined on opposite sides of a protrusion 124 that extends upwardly from the upper surface of the base 110, and each one of the resilient tabs 120A, 120B, independently, is receivable by a respective one of the tab-receiving apertures, for effecting the snap fit engagement, in response to insertion of the shaft 102 into a receptacle defined by the protrusion 124. In this respect, the tab-receiving apertures extends through the thickness of the protrusion 124 and is disposed in communication with the receptacle 112. The snap-fit engagement is effected in response to alignment between the tabs 120A, 120B and the tab-receiving apertures. The tabs 120A, 120B, the receptacle 112, and the tab-receiving apertures are co-operatively configured such that the snap-fit engagement is effectible in response to alignment of the resilient tabs 120A, 120B and the tab-receiving apertures, which is responsive to insertion of the shaft 102 into the receptacle 112.

In some embodiments, for example, while the shaft 102 and the base 110 are releasably coupled via the snap-fit engagement, each one of the resilient tabs 120A, 120B, independently, extends through a respective one of the tab-receiving apertures such that the resilient tabs 120A, 120B projects outwardly relative to the protrusion 124 of the base 110. In this respect, in some embodiments, for example, the snap-fit engagement is defeatable, such that the release of the shaft from the releasable coupling to the base is effected, in response to a force applied inwardly (such as, for example, by a human hand), relative to the central longitudinal axis of the shaft 102, to the resilient tabs 120A, 120B via the apertures. In such embodiments, for example, the inwardly-applied force effects deformation, of the resilient tabs 210A, 120B, sufficient for the resilient tabs to no longer interfere with removal of the shaft 102 from the receptacle (i.e. sufficient for the defeating of the interference fit). In some embodiments, for example, the inwardly-applied force includes pressing of the resilient tabs 120A, 120B. In some embodiments, for example, a slot 121 is defined within the shaft 102, extending from the lower edge of the shaft 102, and is configured to accommodate deformation of the tabs 120A, 120B, responsive to the pressing of the tabs 120A, 120B.

FIGS. 5A and 5F are illustrative of an alternative embodiment of a tamper base 110 for use with the shaft 102 illustrated in FIG. 1B. The base 110 includes an upper surface 114 and a lower surface 116.

In some embodiments, for example, and similar to the embodiment of the base 110 illustrated in FIGS. 2A-2D, the surface portion 116A of the lower surface 116 is configured such that, while the base 110 is being forced to move downwardly through a layer of unconsolidated solid debris (e.g. a pile of leaves), the lower surface portion 116A encourages unconsolidated solid debris to move out of the way of the base 110, and thereby facilitate movement of the base 110 through the layer of unconsolidated solid debris in a downwardly direction. In some embodiments, for example, the lower surface portion 116A is smooth. Alternatively, in some embodiments, for example, the lower surface portion 116A is irregular. In some embodiments, for example, the lower surface portion 116A is tapered upwardly at an acute angle of at least three (3) degrees relative to the horizontal, such as, for example at least five (5) degrees relative to the horizontal, such as, for example, at least 10 degrees relative to the horizontal. In some embodiments, for example, there is an absence of uniformity in the angle of the taper of the lower surface portion 116A.

In some embodiments, for example, the maximum thickness of the base 110 is less than 0.25 inches, such as, for example, less than 0.185 inches, such as, for example, less than 0.06 inches. In some embodiments, for example, to accommodate the taper of the lower surface portion 116A, while also minimizing the use of material, the upper surface 114 defines a concave-shaped surface portion 114B.

So as to lessen the use of material, a female receptacle 112, configured for effecting threadable coupling of the base 110 and the shaft 102, is defined within a projection 126 that extends upwardly from the upper surface 114, and the projection 126 is reinforced by a plurality of ribs 128 disposed about the perimeter of the projection 126 and extending between the upper surface 114 and the projection 126.

Whereas some exemplary embodiments are herein described, it will be evident that numerous modifications are possible. Accordingly, the invention should be understood as limited only by the accompanying claims, purposively construed.

1.-77. (canceled)

78. A kit for assembling a tamping apparatus comprising:
a base;
a shaft; wherein:
the base and the shaft are co-operatively configured for releasable coupling to one another;
the releasable coupling is with effect that a lower surface of the base is disposed for tamping yard waste in response to application of a force to the shaft in a downwardly direction;
the shaft defines a first coupling counterpart;
the base defines a second coupling counterpart; and
the first and second coupling counterparts are co-operatively configured for interacting such that the releasable coupling is effectible by the interacting of only the first and second counterparts.

79. The kit as claimed in claim 78; wherein the releasable coupling includes a threaded connection.

80. The kit as claimed in claim 79; wherein:
the first counterpart includes a male connector, and is defined by the shaft;
the second counterpart includes a female receptacle, and is defined by the base; and
the female receptacle is configured for threadably connecting to the male connector to obtain the threaded connection.

81. The kit as claimed in claim 78; wherein the releasable coupling includes an interference fit-relationship between the base and the shaft.

82. The kit as claimed in claim 81; wherein:
the interference fit-relationship is effectible in response to a snap-fit engagement between the base and the shaft;
the snap-fit engagement is effectible in response to insertion of a resilient tab into a tab-receiving receptacle;
one of the first and second counterparts defines the resilient tab; and
the other one of the first and second counterparts defines the tab-receiving receptacle.

83. The kit as claimed in claim 82; wherein:
the first counterpart defines the tab; and
the second counterpart defines the tab-receiving receptacle.

84. The kit as claimed in claim 82; wherein:
the releasable coupling is such that there is an absence, or substantial absence, of rotatability of the shaft relative to the base.

85. The kit as claimed in claim 82; wherein:
the releasable coupling is such that there is an absence, or substantial absence, of rotatability of the shaft relative to the base, about an axis that is disposed in a plane to which the longitudinal axis of the shaft is orthogonal.

86. The kit as claimed in claim 82; wherein:
the releasable coupling is with effect that the shaft is fixed, or substantially fixed, to the base.

87. A kit for assembling a tamping apparatus comprising:
a base;
a shaft; wherein:
the base and the shaft are co-operatively configured for releasable coupling to one another;
the releasable coupling is with effect that a lower surface of the base is disposed for tamping yard waste in response to application of a force to the shaft in a downwardly direction; and
the releasable coupling includes a threaded connection.

88. The kit as claimed in claim 87; further comprising:
a female receptacle; wherein:
the shaft defines a male connector; and
the female receptacle is threadably connectible to the male connector.

89. The kit as claimed in claim 88; wherein:
the lower surface includes a lower surface portion configured such that, while the base is being forced to move downwardly through a layer of unconsolidated solid debris, the lower surface portion encourages unconsolidated solid debris to move out of the way of the base, and thereby facilitate movement of the base through the layer of unconsolidated solid debris in a downwardly direction.

90. The kit as claimed in claim 89; wherein:
the lower surface portion is tapered upwardly, in an outwardly direction relative to the central longitudinal axis of the shaft.

91. The kit as claimed in claim 89; wherein:
the lower surface portion is tapered upwardly, in an outwardly direction relative to the central longitudinal axis of the shaft, and at an acute angle of at least 3 degrees relative to the horizontal.

92. The kit as claimed in claim 87; further comprising:
a projection that extends upwardly from an upper surface of the base; wherein:
the female receptacle is defined by the projection.

93. The kit as claimed in claim 92; further comprising:
a plurality of reinforcing ribs extending between the upper surface of the base and the projection, and spaced apart about the projection.

94. A kit for assembling a tamping apparatus comprising:
a base;
a shaft; wherein:
the base and the shaft are co-operatively configured for releasable coupling to one another;
the releasable coupling is with effect that a lower surface of the base is disposed for tamping yard waste in response to application of a force to the shaft in a downwardly direction; and
the releasable coupling includes an interference fit relationship between the base and the shaft.

95. The kit as claimed in claim 94; wherein:
the interference fit relationship includes an interaction between a first counterpart and a second counterpart;
the first counterpart includes a resilient tab;
the second counterpart includes a tab-receiving aperture; and
the interference fit relationship includes snap fit engagement between the base and the shaft that is effectible in response to insertion of the resilient tab into the tab-receiving aperture.

96. The kit as claimed in claim 95; wherein:
the first counterpart is defined by the shaft; and
the second counterpart is defined by the base.

97. A kit for assembling a tamping apparatus comprising:
a base;
a shaft; wherein:
the base and the shaft are co-operatively configured for releasable coupling to one another;
the releasable coupling is with effect that a lower surface of the base is disposed for tamping yard waste in response to application of a force to the shaft in a downwardly direction; and
the lower surface includes a lower surface portion configured such that, while the base is being forced to move downwardly through a layer of unconsolidated solid debris, the lower surface portion encourages unconsolidated solid debris to move out of the way of the base, and thereby facilitate movement of the base through the layer of unconsolidated solid debris in a downwardly direction.
